(19) United States
(12) Patent Application Publication
(10) Pub. No.: US 2017/0178259 A1
(43) Pub. Date: Jun. 22, 2017

(54) AUTOMATIC SELECTION OF CALENDAR-BASED, MULTIPLE USER OPTIONS

(71) Applicant: Hipmunk, Inc., San Francisco, CA (US)

(72) Inventor: Adam Julian Goldstein, San Francisco, CA (US)

(21) Appl. No.: 15/370,071

(22) Filed: Dec. 6, 2016

Related U.S. Application Data
(60) Provisional application No. 62/269,743, filed on Dec. 18, 2015.

(51) Int. Cl. G06Q 50/14; G06Q 50/12; G06Q 10/02; G06F 9/44; G06Q 10/10

(52) U.S. Cl. CPC G06Q 50/14; G06F 9/4443; G06Q 10/1093; G06Q 10/02; G06Q 50/12

(57) ABSTRACT

Systems and methods for automatically selecting calendar-based, multiple user options are provided. The system accesses calendar data that describes events a plurality of users are scheduled to attend, and extracts data for each event including location data and time data. The system groups a subset of the plurality of users into a travel group based on the location data for each user in the travel group indicating locations within a predetermined distance threshold of each other and based on the time data for each user in the travel group indicating times within a predetermined time threshold of each other. The system automatically generates an application program interface (APT) requests using the extracted data for the travel group, and transmits the API request to a service provider. The system receives and presents results which includes a group travel option indicating a block of inventory selected for the travel group.

### CROSS REFERENCE TO RELATED APPLICATION

The present application claims the priority benefit of U.S. Provisional Patent Application Serial No. 62/269,743, filed on Dec. 18, 2015 and entitled “Calendar-Based Multiple Customers Travel Options,” which is incorporated herein by reference in its entirety.

### TECHNICAL FIELD

The subject matter disclosed herein generally relates to machines configured to the technical field of special-purpose machines that facilitate generation and provision of user interfaces (e.g., within webpages) comprising automatically selected options, including computerized variants of such special-purpose machines and improvements to such variants, and to the technologies by which such special-purpose machines become improved compared to other special-purpose machines that facilitate provisioning of user interfaces comprising automatically selected options. Specifically, the present disclosure addresses systems and methods to cause presentation of user interfaces providing automatically selected, multiple user options based on extracted calendar data from a plurality of users.

### BACKGROUND

An online service may allow a user of the online service to view multiple options for plans and make a selection from the multiple options based on manual user inputs. For example, an airline may operate a webpage that provides an online reservation service from which a user may manually search for available flights (e.g., from San Francisco to New York) on a particular day and then select one of the available flights for reserving a seat thereon. As another example, a hotel may operate a webpage that provides an online reservation service from which the user may manually search for available hotel properties and room types (e.g., in New York) for a particular period of time (e.g., September 5 through September 9) and then select one of the available room types at an available hotel property for reserving. As a further example, a restaurant may offer a webpage that provides an online reservation service from which the user may manually search for available table reservations (e.g., at a popular restaurant) within a particular range of times (e.g., 5:30 PM to 7:30 PM) on a particular date and then select one of the available table reservations for reserving. In all of these instances, the user must be proactive in visiting different websites and entering search criteria in order to compare and select different types of options (e.g., flight, car, hotel, restaurant reservations).

### BRIEF DESCRIPTION OF THE DRAWINGS

Some embodiments are illustrated by way of example and not limitation in the figures of the accompanying drawings.

FIG. 1 is a network diagram illustrating a network environment suitable for automatic selection of calendar-based multiple user options for presentation, according to some example embodiments.

FIG. 2 is a block diagram illustrating components of a suggestion server, according to some example embodiments.

FIG. 3 is a block diagram illustrating calendar data accessed by the suggestion server, according to some example embodiments.

FIG. 4 is a flowchart illustrating operations of a method for automatic selection and presentation of calendar-based multiple user options, according to some example embodiments.

FIG. 5 is a flowchart illustrating operations of a method for managing a charter flight option, according to some example embodiments.

FIG. 6 is a block diagram illustrating components of a machine, according to some example embodiments, able to read instructions from a machine-readable medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e,g., structural components, such as modules) are optional and may be combined or subdivided, and operations (e.g., in a procedure, algorithm, or other function) may vary in sequence or be combined or subdivided.

Example methods (e.g., algorithms) facilitate automatically selecting options (e.g., travel options) based on calendar data of a plurality of users, and generating and provisioning of user interfaces (e.g., within wehpages) comprising these calendar-based options for at least some of the plurality of users (e.g., a plurality of consumers or a plurality of travelers). Example systems (e.g., special-purpose machines) are configured to automatically select options (e.g., travel options) based on calendar data of the plurality of users, and generate and provision user interfaces comprising these calendar-based options for one or more of the plurality of users. In particular, example embodiments provide mechanisms and logic that determines options to be presented on one or more user interfaces to at least some of the plurality of users and causes the user interfaces to be presented.

More specifically, calendar-based, multiple user options (e.g., options that correspond to multiple users) presented on the user interfaces involve displaying suggested options derived from one or more events stored in a calendar of each user among the plurality of users. Calendar-based suggestion of options (e.g., travel options) for multiple users involves suggesting options based on detecting that multiple users have calendared events associated with a same geographic location (e.g., within the same city, zip code, neighborhood, or building) within a same or similar time frame (e.g., within two days of each other). Accordingly, a suggestion server accesses (e.g., receives or retrieves) calendar data of a plurality of users, and extracts particular data from the calendar data (e.g., a location of the event or a time frame of a corresponding event). The extracted data is analyzed to determine that a subset of the plurality of users will be traveling to or from a same geographic location or have events in a same geographic location within a similar time frame. This subset of the plurality of users is grouped into a travel group.

The extracted data may be made available to service providers, via an application program interface (API) request (e.g., an API call), for available travel options that may include special discounts, special inventories, or special extras upgrades, free breakfast, parking, or meals included) based on (e.g., in response to) the extracted calendar data, user preferences, preferences of other similar users, or any suitable combination thereof. In some example embodiments, the extracted data for the subset of the plurality of users are presented to the service provider as a single group of travelers (also referred to as a “travel group”) that may book a block of inventory (e.g., a block of rooms or a block of seats on an airline) together. The suggestion server may also present the extracted data as a separate API request for each user individually. A result of the API request includes a group travel option indicating a block of inventory (e.g., a block of rooms, airline seats, or tickets) selected for the travel group that may provide an added benefit (e.g., amenities, discounts, upgrades) that is not available from individual travel options for individual users.

In one example embodiment, the extracted data is shared with the service providers (e.g., servers of the service providers) at a specific level. For example, the API request comprises fields for entry (or inclusion) of information for each calendared event by the suggestion server. The fields may include an event type field and a location field (e.g., latitude/longitude, neighborhood, or city) such that the service provider knows that each user or the travel group will be in a particular location and/or performing some action (e.g., eating at a restaurant, going to a meeting, going to a sports event). In response, the service provider can provide options (e.g., hotel room options) or near each of the particular locations for each user or for the travel group as a whole. The options may comprise options from multiple service providers aggregated by the suggestion server. As such, the suggestion server may make multiple API calls to servers of different service providers and aggregate a plurality of results from different service providers, and provide a user interface that comprises the plurality of results or a subset of the plurality of results (e.g., curated, top results).

In an alternative example embodiment, the suggestion server can use artificial intelligence, machine-learning, and data processing algorithms to determine a likely interest level of each user for a particular type or level of service (e.g., 5 star hotel versus a 3 star hotel). For example, if the suggestion server detects a user is going to a meeting in a fancy building in downtown Chicago (e.g., based on available information on neighborhood, zip code, star rating, owner, or tenant) and then going to a dinner in a fancy restaurant (e.g., based on reviews or star rating), the suggestion server infers that the user is probably on an expense account or likely affluent. Thus, the suggestion server can infer whether a particular user is likely extremely affluent, moderately affluent, a budget travel, and so forth based on the extracted data. A more affluent user is more likely to prefer, for example, luxury hotel options, business class flights options, and luxury car service options. As another example, users traveling to Disney World would be more likely to be interested in hotels with family-friendly amenities. Accordingly, the suggestion server can group (or further group) the users based on their preferences or their inferred type or level of service. Furthermore, the suggestion server can proactively offer suggestions to the service providers as to a type or level of travel option to return in their results (e.g., 5 star hotels, first class airline seat, or budget motel) for users individually and as a travel group.

Whether the service provider returns customized results (e.g., customized to the anticipated type or level of travel option preferred by the user or group of users) or general results (e.g., same results to any user running a general search), the suggestion server takes the results and determines best travel options for the users. For example, the suggestion server connects with Hotel 1 and Hotel 2. Hotel 1 has a sophisticated search system in which if Hotel 1 knows the last meeting time and location and that the users are affluent, the search system of Hotel 1 has logic to only return the nicest rooms and higher upgrades in their results. Conversely, Hotel 2 only connects using their standard API and returns general results that are not customized to the users. The suggestion server analyzes the search results and derives a result set that is relevant to the users. For example, the search results are weighed, sorted, and ranked, and a top number of travel options are provided to each of the users. Alternatively, all search results can be provided with top travel options highlighted.

The suggestion server is configured to present this result set of travel options to the users of the travel group (e.g., as suggestions for making a hotel reservation). For example, when the users visit a website associated with the suggestion server, the result set of options will be presented in one or more customized user interfaces. In other example embodiments, a notification or message is sent to each user of the travel group providing the result set, or indicating that the result set is available for viewing on the website and providing a link to the website and the customized user interfaces.

As used herein, a “travel option” is an option (e.g., choice, offering, alternative, menu item, or special deal) of potential interest to a user (e.g., as a user of an online service) in making or executing a travel plan (e.g., an itinerary). A travel option may be a “transportation option” pertinent to a transportation service or a vehicle. Examples of transportation options include travel by airplane, train, bus, trolley, ferry, ship, taxicab, rental car, car sharing service, or any suitable combination thereof. Transportation options may include transportation services (e.g., passenger service) provided by commercial carriers (e.g., airlines, car rental companies, or cruise operators), public transportation (e.g., city buses or regional trains), private operators (e.g., limousine services, charter airplanes, or charter helicopters), or any combination thereof. In some example embodiments, the transportation option specifies that the traveler walk, jog, hike, or ride a bicycle to a particular destination. A travel option may be an “accommodation option” pertinent to an accommodation (e.g., hospitality) service. Examples of accommodation options include stays in a hotel, motel, resort, hostel, bed-and-breakfast inn, boarding house, vacation rental, home sharing service, campground, or any suitable combination thereof. Further examples of accommodation options include reservations at a restaurant, conference facility, health facility (e.g., spa, salon, or massage studio), athletic facility (e.g., gym, pool, or fitness center), or entertainment venue (e.g., theater, sports stadium, amusement park, or museum). In some situations, a travel option may be both a transportation option and an accommodation option (e.g., a compartment in a passenger train, a cabin on a cruise ship, or a bed on an overnight airline flight). A further example of a travel option is trip insurance (e.g., an insurance policy for a set of transportation options, accommodation options, or both).

As a result, one or more of the methodologies described herein facilitate solving the technical problem of providing user interfaces presenting customized information from multiple service providers to a group of users (e.g., the travel group). The methodologies include accessing calendar data of a plurality of users. The logic also extracts data from the calendar data including location data and time data for each event. The logic groups a subset of the plurality of users into a travel group based on the location data for each event the subset of the plurality of users is scheduled to attend indicating a location within a predetermined distance threshold and based on the time data for each event the subset of the plurality of users is scheduled to attend indicating a time within a predetermined time threshold. The extracted data is used to automatically generate (e.g., construct) an application program interface (API) request, whereby the extracted data is used as, or is associated with, one or more search criteria in the API request. The API request is transmitted to one or more service providers e.g., to a server of each service provider), and. results compatible with the events are received in response to the API request. The logic constructs a user interface comprising at least some options from the results and causes the user interface to be presented to a device of each user of the travel group. As such, one or more of the methodologies described herein may obviate a need for certain efforts or resources that otherwise would be involved in users having to navigate to a plurality of service providers (e.g., the user is retained from navigating away from a website of an entity comprising the suggestion server) and performing numerous searches at each service provider in order to determine different options based on multiple events. As a result, resources used by one or more machines, databases, or devices (e.g., within the environment) may be reduced, and the user is retained at the website of the entity having the suggestion server. Examples of such computing resources include processor cycles, network traffic, memory usage, data storage capacity, power consumption, network bandwidth, and cooling capacity.

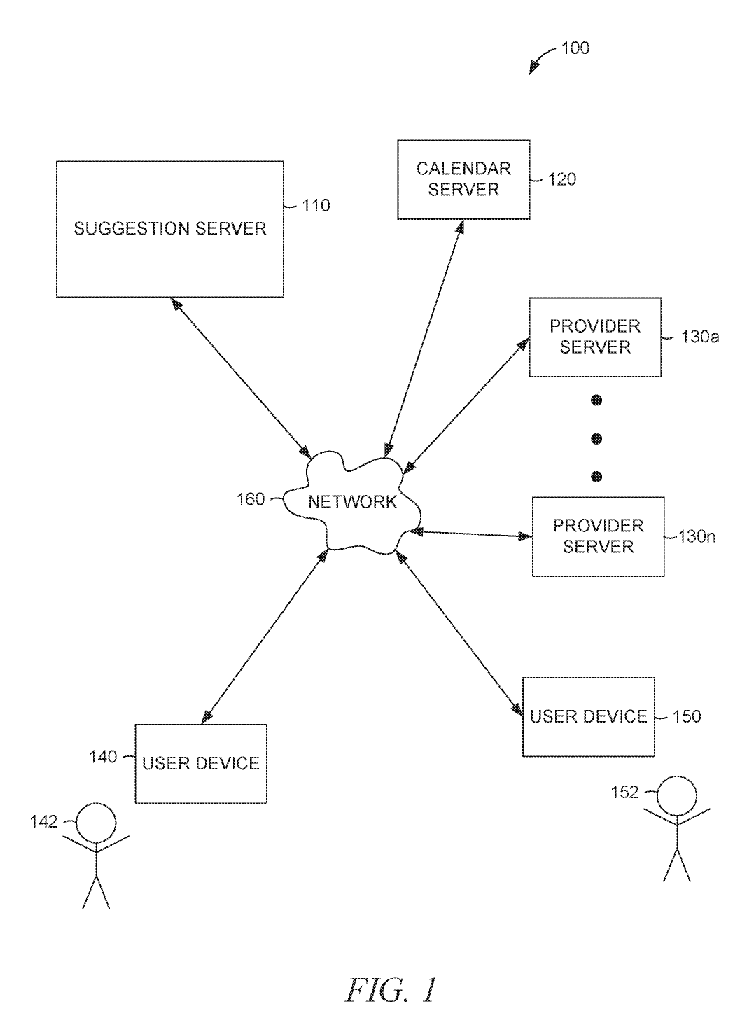

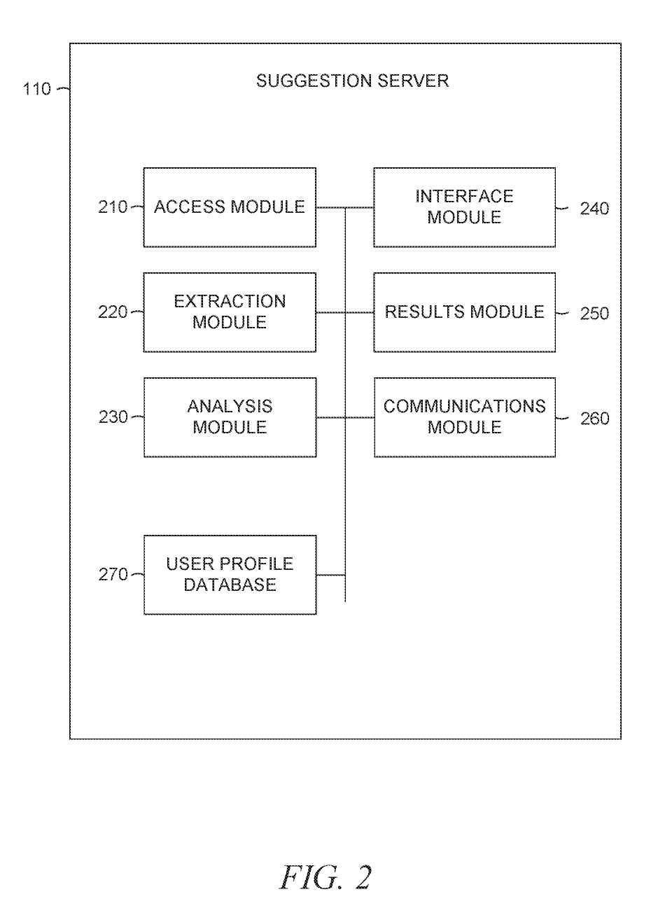

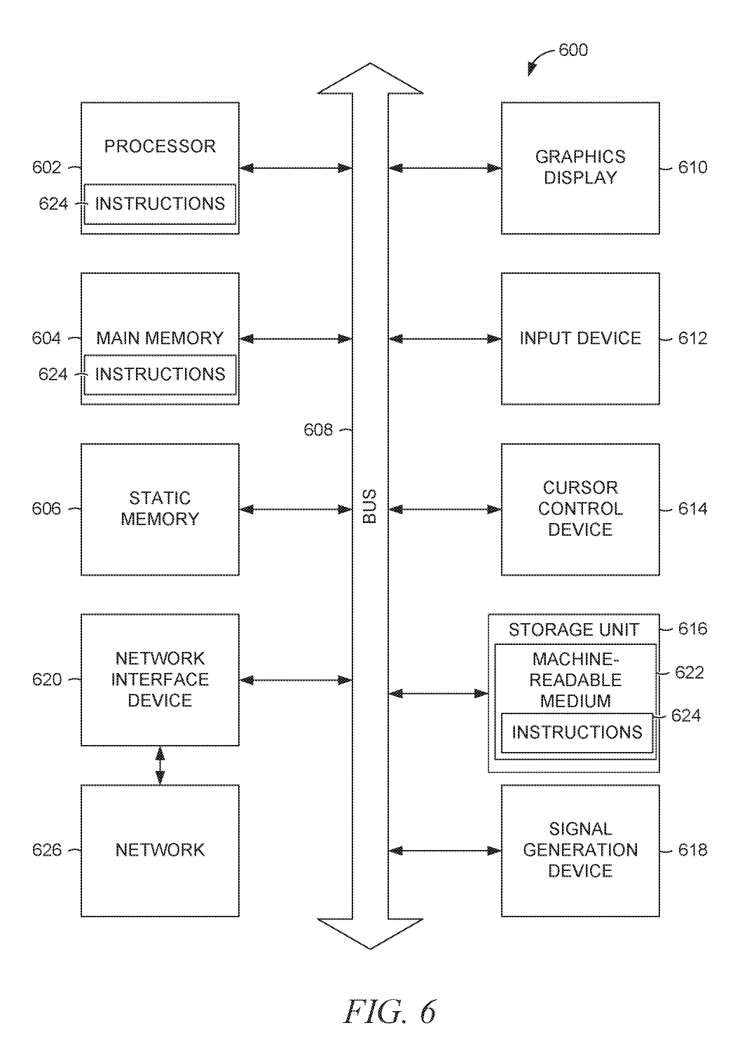

FIG. 1 is a network diagram illustrating a network environment 100 suitable for generating and presenting user interfaces comprising automatically selected calendar-based options (e.g., travel options) to multiple users as a travel group, according to some example embodiments. The network environment 100 includes a suggestion server 110, a calendar server 120, one or more provider servers 130a-130n (collectively referred to as provider server 130), and user devices 140 and 150, all communicatively coupled to each other via a network 160. In some example embodiments, the suggestion server 110 and the calendar server 120 may form all or part of a calendar service system that provides calendar-related services to one or more users (e.g., event scheduling or project management). In certain example embodiments, the suggestion server 110 and the provider server 130 may form all or part of a travel service system that provides travel-related services to one or more users (e.g., merchandising of travel options or itinerary management). In various example embodiments, the suggestion server 110, the calendar server 120, and the provider server 130 form all or part of a combined system. The suggestion server 110 is described in more detail in connection with FIG. 2 and may be implemented in a computer system, as described below with respect to FIG. 6.

The calendar server 120 functions as a data repository that stores calendar data of the plurality of users. In some example embodiments, the calendar server 120 is operated by a third-party calendar service (e.g., Google or Yahoo).

The provider server 130 functions as a data repository that stores data describing one or more options (e.g., travel options). In certain example embodiments, the provider server 130 is operated by a third-party service provider (e.g., a travel agency, an airline, or a hotel management company). In some example embodiments, the provider server 130 is operated by a third-party service provider that provide services that are tangentially related to travel. For example, the third party service provider may provide pet services (e.g., boarding services, pet walker), house sitting services, or babysitting services.

Also shown in FIG. 1 are users 142 and 152. One or both of the users 142 and 152 may be a human user (e.g., a human being), a machine user (e.g., a software program configured to interact with the user device 140), or any suitable combination thereof (e.g., a human assisted by a machine or a machine supervised by human). The user 142 is not part of the network environment 100, but is associated with the user device 140 and may be a user of the user device 140. For example, the user device 140 may be a desktop computer, a tablet computer, or a smartphone belonging to the user 142. Similarly, the user 152 is not part of the network environment 100, but is associated with the user device 150. As an example, the user device 150 may be a tablet computer belonging to the user 152. While only two users (e.g., user 142 and 152 are shown in FIG. 1), any number of users may interact via their respective user device with the network environment 100.

Any of the machines, databases, or devices (each also referred to as a “machine”) shown in FIG. 1 may be implemented in a general-purpose computer modified (e.g., configured or programmed) by software to be a special-purpose computer to perform the functions described herein for that machine. For example, a computer system able to implement any one or more of the methodologies described herein is discussed below with respect to FIG. 6. As used herein, a “database” is a data storage resource and may store data structured as a text file, a table, a spreadsheet, a relational database, a triple store, a key-value store, or any suitable combination thereof. Moreover, any two or more of the machines illustrated in FIG. 1 may be combined into a single machine, and the functions described herein for any single machine may be subdivided among multiple machines.

The network 160 may be any network that enables communication between machines (e.g., the suggestion server 110 and the user device 140). Accordingly, the network 160 may be a wired network, a wireless network (e.g., a mobile network), or any suitable combination thereof. The network 160 may include one or more portions that constitute a private network, a public network (e.g., the Internet), or any suitable combination thereof.

FIG. 2 is a block diagram illustrating components of the suggestion server 110, according to some example embodiments. The suggestion server 110 includes an access module 210, an extraction module 220, an analysis module 230, an interface module 240, a results module 250, and a communications module 260, all configured to communicate with each other (e.g., via a bus, shared memory, or a switch). The suggestion server 110 also includes a user profile database 270 that is configured to communicate with the other components of the suggestion server 110. Any one or more of the modules described herein may be implemented using hardware (e.g., a processor of a machine) or a combination of hardware and software. Moreover, any two or more of these modules may be combined into a single module, and the functions described herein for a single module may be subdivided among multiple modules.

The access module 210 is configured to access calendar data of the plurality of users (e.g., user 142 and user 152, travelers, potential travelers, consumers of travel options, or potential consumers of travel options). The access module 210 may access (e.g., receive or retrieve) the calendar data from the calendar server 120, for example, by using an API call. In some example embodiments, the suggestion server 110 locally stores the calendar data (e.g., in the user profile database 270), and the access module 210 accesses the calendar data from the suggestion server 110. The calendar data includes information describing one or more calendared events in the calendars of each of the plurality of users (e.g., scheduled for each of the plurality of users). Accordingly, the calendar data indicates a time frame (e.g., period of time) during which the users are scheduled to participate in (e.g., attend) a calendared event along with a location for the calendared event. For example, the calendar data may indicate that a user is scheduled to attend a dinner in Chicago on Monday, September 5, from 7 PM to 9 PM Central Time and a second user is scheduled to attend a meeting in Chicago on Monday, September 5, from 2 PM to 4 PM.

The extraction module 220 is configured to extract calendar data that is used to facilitate a search for options (e.g., travel options or menu options), and also used to determine whether a travel group can be formed with two or more of the users. For example, the extraction module 220 extracts location data (e.g., Chicago) and time data (e.g., September 5^{th}, 7 PM to 9 PM). In some example embodiments, the extracted data is provided to the analysis module 230 for processing. In some example embodiments, the extracted data is provided to the interface module 240 and transmitted to service providers (e.g., provider servers 130) via an API call to initiate one or more searches for options from the service providers.

The analysis module 230 is configured to determine whether the extracted data indicates that two or more users are traveling to or from a same geographic location within a similar time frame. Accordingly, the analysis module 230 receives the extracted data and determines whether the calendared events identified from the extracted data indicate, for example, that two or more users are traveling from a same first location to a same second location on a same day and will require flights to the second location. In another example, two or more users may be traveling from different first locations but to the same second location such that it makes sense for them to take two different first legs of the flights but connect onto the same second leg (e.g., from two different small cities in Hawaii to San Francisco, in which case it may make sense to route both of them to Honolulu and then onto the same flight to San Francisco). Conversely, users from a same first location can fly the first flight together, but then have connections that take them from their shared first flight onto two different connecting flights. In yet another example with a three-leg flight itinerary, the users may share the middle leg. Thus, if any component of the users' travel is the same, the analysis module 230 may group the users for that component, even if the entire trips are not the same. In another example, the analysis module 230 determines whether two or more users are arriving in a same location on a same day and require hotel rooms. These users that require flights or hotel rooms in the same location or on the same days may be grouped into a travel group in an attempt to create a virtual room block or virtual airline seat block.

In some example embodiments, the access module 210 detects, in a span of a predetermined time period (e.g., an hour), that a number of users have added a trip to a same geographic location (e.g., Austin, downtown Chicago) within a same time frame (e.g., same day or within two days of each other) to their calendars. In these embodiments, the analysis module 230 may automatically group these users into a travel group in an attempt to create a virtual room block or virtual airline seat block. The users in the travel group may not know each other or have any affiliation with each other.

The analysis module 230 is also configured to analyze the extracted data to infer a level or type of service that may be applicable to the plurality of users. Returning to one of the examples above, the analysis module 230 receives the name of a restaurant (e.g., Alinea) for the user 142 and determines that the restaurant is a high-end, expensive restaurant (e.g., based on information retrieved regarding the restaurant). Based on this determination, the analysis module 230 infers that the user 142 is likely very affluent, traveling on an expense account, or prefers a higher level of service. This determination may be used to group the user 142 with other affluent users traveling to a same location during a similar time frame, and trigger a customized search for travel options for a travel group comprising the affluent users. The inferred level or type of service for the user 142 may be stored in a profile of the user 142 in the user profile database 270.

The analysis module 230 is further configured to infer user preferences from past calendared events. For example, if the user 142 has stayed at a Hilton hotel for the last four trips, the analysis module 230 infers that the user 142 prefers to stay at Hilton hotels. In another example, if the user 142 is new, the analysis module 230 can detect that the last five flights from their calendared events were on American Airlines, so the analysis module 230 infers that the user 142 is loyal to American Airlines. These inferred user preferences may be used to group users having similar user preferences into a same travel group to create a virtual room block or virtual airline seat block. As another example, if the analysis module 230 detects that the user 142 tends to “cut it close” and book flights that depart very shortly after a prior meeting, the analysis module 230 infers that flights that leave soon after meetings should be provided to the user even though most other customers would not want to see these flights. As a further example, the analysis module 230 can detect that the user 142 tends to stay at hotels very close to meetings and infer that the user 142 likes to be within walking distance so as not to rent a car. Conversely, the analysis module 230 may detect that the user 142 tends to stay at hotels far from meetings and that the user 142 is therefore willing to rent a car if it will save money on hotels or if the user 142 can stay at a nicer hotel. Further still, if the user 142 takes frequent trips to a particular location (e.g., London), this information can be provided in the API call/request so that the service providers know to offer extra amenities to secure the user's long-term loyalty on future trips to that location. In some cases, these inferred user preferences may be used to group users having similar user preferences into a same travel group to create a virtual room block or virtual airline seat block. The inferred preferences for each user may be stored in the profile of each user in the user profile database 270.

The interface module 240 is configured to communicate via an API with one or more provider servers 130 (e.g., server of a service provider). In some example embodiments, the interface module 240 provides some or all of the extracted data directly to the provider server 130 (e.g., in fields of an API request). The provider server 130 then performs a search of their inventory for options that match at least part of the extracted data. Depending on the capability of the provider server 130, results of the search may be customized to a type or level of service that would appeal to the travel group or to a user type of the travel group (e.g., affluent traveler, budget traveler, business traveler, traveler with kids) and may include specific types of discounts, upgrades, or extra amenities that would appeal to the travel group. Upgrades and extra amenities can be up to the service providers to provide, or the suggestion server 110 (e.g., the analysis module 230) can provide suggestions to the provider server 130. For example, the suggestion server 110 may indicate that the users in the travel group, based on history of the users or similar type of user, are most likely to pick an option if it includes free breakfast. As such, the logic can be left to the provider server 130 to customize the results, or the suggestion server 110 can provide guidance to the provider server 130 and the provider server 130 can use the guidance. For provider servers 130 that are not sophisticated search systems, the results may be general results that any user of the provider server 13( )would receive using a standard API of the provider server 130.

In some example embodiments, the interface module 240 is configured to construct and transmit multiple API calls for travel options. A first API call is performed for the travel group in an attempt to obtain a group discount with a virtual block of inventory (e.g., virtual room block, virtual airline seat block, virtual entertainment ticket block). Further API calls may be made for individual users or a subset of the travel group. In some situations, less expensive travel options may be obtained for individual users or the subset of the travel group. For example, if only one seat is left on a flight at a lower price, an API call for more than one seat (e.g., an API call for a travel group) may not discover this lower price travel option.

The results module 250 is configured to determine best or optimal options to present to the users. The best options may be based on a combination of one or more factors such as cost, what the users are getting (e.g., free breakfast, suite vs. room, free WiFi), customer reviews including customer reviews specific to the users' demographics, user preferences (e.g., from the user profile database 270), an inferred user type or level of service (e.g., from the analysis module 230 or user profile database 270), and commission levels for an owner of the suggestion server 110. The user preferences can be explicitly provided by the users (e.g., users previously filled out a form or user interface that indicates preferences for airlines, times for flights, hotels, or room types that is stored to the user profile database 270). The user preferences can also be interred from past purchases or calendared events as discussed above with respect to the analysis module 230.

In some example embodiments, the results module 250 comprises an algorithm that applies weights and scores to these factors. In some example embodiments, the results module 250 assigns extra weight to a service provider or option that is providing something unique to the users (e.g., lower rate than a public rate). Whether an option contains a unique aspect can be determined in several ways. For example, the suggestion server 110 can directly query the provider server 130 if the provider server 130 is providing a unique benefit to the users. Alternatively, the suggestion server 110 (e.g., the interface module 240) can perform multiple API calls for search results. A first API call is made via a special API to the provider server 130 that results in the customized search results being returned. A second API call is made using a standard API (e.g., available to the general public) of the provider server 130 that results in standard search result. The results module 250 then compares the options from the two search results to determine whether and what the unique amenities or benefits are. In some example embodiments, the unique amenities and benefits may be weighted differently. For example, a free room upgrade may be weighted higher than free breakfast or free WiFi. In some example embodiments, the results module 250 comprises or accesses logic or stored data (e.g., weight table stored in memory) that indicates a weight to apply.

The results module 250 can also determine whether, for flight travel options, a charter flight option should be presented. In some example embodiments, the results module 250 may determine that the flight options received in response to the API call(s) are expensive (e.g., as compared to empirical or historical data). If there is a threshold number of users that require a flight to the same destination location from the same origination location within a similar timeframe, the results module 250 may offer a charter flight option. For example, if there are 20 users requiring such a flight and commercial fares (e.g., on a commercial airline) are $800 per passenger and a charter flight would cost $500 per passenger, the results module 250 offers an option for the charter flight. The charter flight option may indicate that a required number of users (e.g., 15 users) need to agree by a particular date and provide a refundable deposit. If the required number of users have not agreed to the charter flight option by the particular date, the deposit is refunded and the users are presented travel options obtained from the API call(s).

The communications module 260 is configured to present the options to the users. The communications module 260 may present the options by generating and displaying or causing the display of a user interface or webpage (e.g., of a travel option search service), a notification (e.g., a pop up window), a message (e.g., an e-mail message, instant message, or a text message), or any suitable combination thereof. In some example embodiments, the communication module 260 presents the option in a communication directed at the users, in a communication addressed to the user devices of the users, or both. Such a communication may present the options including any possible charter options (e.g., for consideration by the users). The communication (e.g., the notification or message) may include a link to a user interface (e.g., provided by a website associated with the suggestion server 110) comprising the options to be presented to the user.

The user profile database 270 stores user profile information of the users for access by components of the suggestion server 110. The user profile information may include, for example, home location (e.g., home address, home airport, origination location), inferred or explicitly provided user preferences (e.g., prefers 5 star hotels, prefers high floors away from elevators, prefers business class seats, prefers driving instead of flying if a trip is less than 100 miles), service provider membership information (e.g., airline frequent flier number, hotel loyalty membership number), and inferred user type.

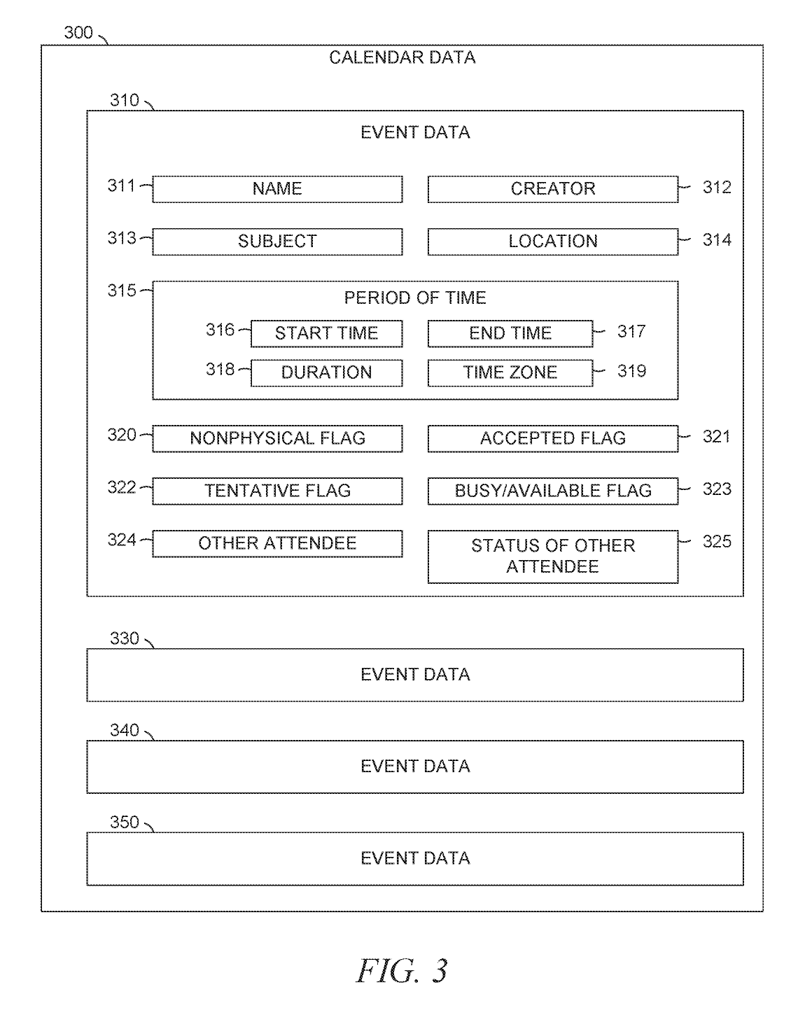

FIG. 3 is a block diagram illustrating calendar data 300 (e.g., as accessed by the access module 210), according to some example embodiments. The calendar data 300 includes information describing one or more events. As shown, an expanded view of event data 310 describes a calendared event (e.g., a phone call, a business meeting, a multi-day conference, a week-long vacation, dinner reservations, or sports events). Similarly, event data 330, 340, and 350 describe additional calendared events (e.g., each event having its own location). The calendar data 300 may be limited to events of a single user (e.g., user 142). According to various example embodiments, one or more of the following data structures may be omitted.

The event data 310 includes one or more of a name 311 of an event (e.g., a title), a creator 312 of the event (e.g., the user 142 or an assistant thereof), a subject 313 of the event (e.g., a description or note), and a location 314 of the event (e.g., room number, floor number, venue name, address, city, state, country, cross streets, or global positioning system (GPS) coordinates). The event data 310 also includes a period of time 315 for the event. The period of time 315 includes a start time 316 (e.g., 10 AM), an end time 317 (e.g., 12 PM), a duration 318 (e.g., two hours), and a time zone 319 (e.g., Eastern Time). In some example embodiments, the period of time 315 includes multiple time zones (e.g., time zone 319). According to various example embodiments, the event data 310 includes a nonphysical flag 320 (e.g., indicating that the event is a virtual or online event), an accepted flag 321 (e.g., indicating that the event has been accepted into the calendar of the user 142), a tentative flag 322 (e.g., indicating that the event is tentatively scheduled for the user 142), and a busy/available flag 323 (e.g., indicating whether the user 142 is busy or available for additional events during the period of time 315). Moreover, in some example embodiments, the event data 310 includes information on one or more additional attendees. As shown, the event data 310 includes an “other” attendee 324 of the event (e.g., a name of another attendee) and a status 325 of the other attendee (e.g., whether the other attendee 324 is scheduled to attend the event). In various example embodiments, the other attendee 324 is a friend, family member, coworker, colleague, or a client of the user 142. In certain example embodiments, multiple “other” attendees are specified in the event data 310. Each of the event data 330, 340, and 350 may include information similar to that described for the event data 310.

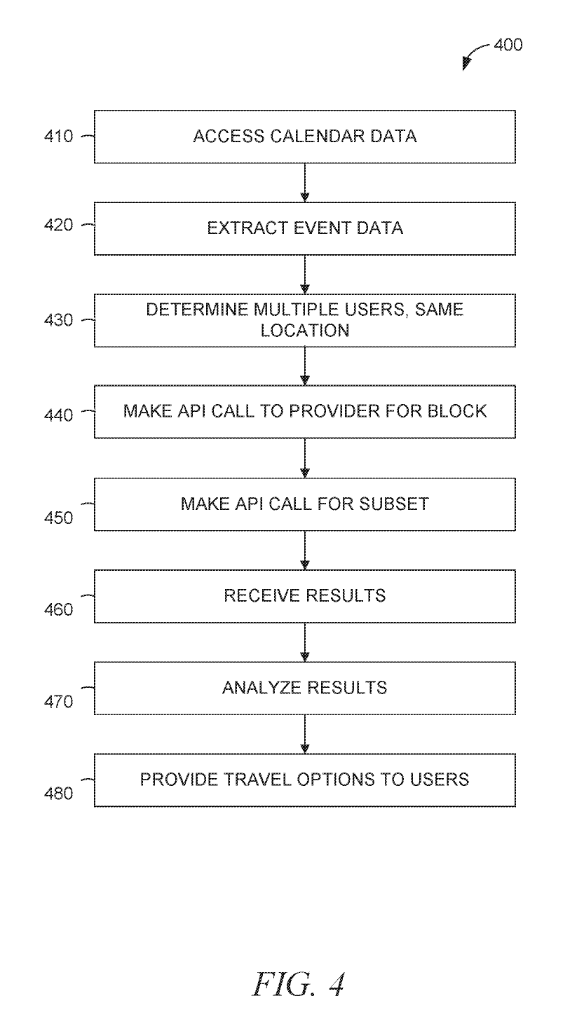

FIG. 4 is a flowchart illustrating operations of a method 400 for automatic selection and presentation of calendar-based suggestions of options for multiple users, according to some example embodiments. Operations in the method 400 may be performed by the suggestion server 110, using modules described above with respect to FIG. 2. Accordingly, the method 400 is described by way of example with reference to the suggestion server 110. However, it shall be appreciated that at least some of the operations of the method 400 may be deployed on various other hardware configurations or be performed by similar components residing elsewhere in the network environment 100. Therefore, the method 400 is not intended to be limited to the suggestion server 110.

In operation 410, the access module 210 accesses the calendar data 300 (e.g., from the calendar server 120) for a plurality of users. The calendar data 300 may indicate location and the period of time 315 or timeframe (e.g., a first period of time) during which each of the plurality of users is scheduled to participate in one or more calendared events (e.g., a business meeting). In some example embodiments, operation 410 is performed by invoking an application programming interface (API) (e.g., a public API) provided by a third-party calendar service (e.g., Google®) to access the calendar data 300 of the third-party calendar server. For example, the API may be invoked in response to the users providing login credentials (e.g., username and password) to identify or authenticate themselves to the suggestion server 110, to the calendar server 120, to the provider server 130, or any suitable combination thereof. In certain example embodiments, operation 410 is performed by receiving the calendar data 300 from the calendar server 120. As an example, the calendar data 300 may be received from the calendar server 120 in response to a request submitted by users to the calendar server 120. As another example, the calendar data 300 may be received from the calendar server 120 as part of a data feed (e.g., a periodic or repeating download) arranged or authorized by the users. According to some example embodiments, operation 410 is performed in response to a query submitted by users (e.g., via their respective user device). For example, the users may query the name of a city (e.g., San Francisco or New York City), and the access module 210 may access the calendar data 300 in response to the submission of the query (e.g., as detected by the suggestion machine 110, the calendar server 120, the provider server 130, or any suitable combination thereof).

In operation 420, the extraction module 220 extracts event data 310 from the calendar data. The extracted data is used to facilitate a search for travel options. For example, the extraction module 220 may extract event type or subject 313 (e.g., meeting, dinner), location 314 (e.g., Alinea, Chicago) and time data (e,g., start time 316, end time 317, duration 318) for each event. In some example embodiments, the extracted data may be for one or more events over a predetermined date range (e.g., 2 week period).

In operation 430, the analysis module 230 determines that there are multiple users that have calendared events (or are planning events) starting or ending in a same or similar location (e.g., same city, same zip code or area code, same county, same neighborhood (e.g., downtown, financial district), same building, or same block (e.g., street address or block of street address). For example, the analysis module 230 determines there are a subset of the plurality of users having calendared events, identified by the extracted data, that are within a predetermined distance threshold (e.g., in the same city, in the same zip code) and a predetermined time threshold (e.g., same day, with two days) that results in a determination that the subset of users are traveling from or to a same location (e.g., same city or within a particular distance of the same city) within a same or similar timeframe (e.g., within a range of two days). In an alternative example embodiment, the determination that the subset of users are traveling to the same destination may be a function of both of these thresholds and other thresholds, such as a function of both time and distance (e.g., it is determined that two users may stay at the same hotel if the sum of a time (e.g., number of hours) between their meetings and the distance between their meetings in miles is less than a predetermined threshold). These users are then grouped together to create a travel group for which blocks of travel options or inventory may be searched, presented, and selected by these users.

In operation 440, the interface module 240 generates at least one API request and makes an API call to one or more provider servers 130 using extracted data for the travel group. For example, if five users are all arriving in Chicago on the same day, the API request may include a field indicating that five hotel rooms are needed for the travel group. In another example, if three users are flying from San Francisco to Chicago on the same day, the API request may include a field indicating that three seats are needed for a flight from San Francisco to Chicago for the travel group.

In some example embodiments, rather than simply calling the service provider's standard API, the interface module 240 provides additional data in a special API. The additional data can be just indicating to the special API that the travel group include users that are members associated with the suggestion server 110 to providing more sophisticated information (e.g. indicating to the special API that one of the user's last meeting of the day is at 9 PM on the Upper East Side of Manhattan). As such, the interface module 240 can provide some or all of the extracted data, via a special API, to a provider server 130 that has logic to handle customized searches based on the extracted data. For example, the provider server 130 is provided the location data, time data, type or level of service for the travel group, and suggested options (e.g., this type of user prefers free breakfast), and is capable of returning customized results.

In addition, the interface module 240 can include recommendations (within the API call) on what discounts or extra amenities the service provider should offer to maximize their likelihood of obtaining a booking. In some example embodiments, the interface module 240 suggests a threshold discount or extra amenities in the API call (e.g. “only give us results that are discounted at least 20%” or “only give us results that include free upgrades” or “you're twice as likely to be booked if your discount is more than 20%”) to motivate service providers to do so. Alternatively, the interface module 240 uses a standard API of a provider server 130 that does not have a special API and provides appropriate search criteria to the provider server 130 (e.g., general date and location information).

In operation 450, the interface module 240 generates at least one API request and makes an API call to one or more provider servers 130 using extracted data for a subset of the travel group (e.g., individual users, or a group of one or more users but less than the entire travel group). Referring back to the example with three users flying from San Francisco to Chicago on the same day, the interface module 240 may generate an API request for each of the three users separately (e.g., searching for one airline seat at a time). The interface module 240 may also generate API requests for a subset of the travel group. For example, one API request is made for a single seat for one user and one API request is made for two seats (e.g., grouping two of the users together). In some example embodiments, operation 450 is optional.

In operation 460, the results module 250 receives the results for each of the API calls. The results may include one or more travel options for the travel group (also referred to as “group travel options”) as well as travel options for individual users or a subset of the travel group. In some instances, the travel options for the travel group may comprise blocks of inventory (e.g., blocks of hotel rooms, airline seats, or event tickets) that provide a benefit (e.g., better price, better amenities, better class of service) over travel options for individual users or a subset of the travel group. In other instances, some of the travel options for individual users or the subset of travel groups may provide a benefit over travel options for the travel group.

Depending on the capability of the provider server 130, results of each search may be customized to the type or level of service that would appeal to the users or to a user type of the users (e.g., affluent traveler or budget traveler) and may include specific types of discounts, upgrades, or extras that would appeal to the user 142, and can include options (e.g., upgrades and extras) suggested by the suggestion server 110 (e.g., by the interface module 240 in the API request). For example, a service provider with a special API can return a different set of inventory or travel options versus a general API (e.g., 10 hotels on the Upper East Side rather than 10 hotels spread all around New York). In another example, the service provider returns the same inventory as with a standard API, but with discounts or other amenities (e.g., free upgrades, free breakfast) not available to the public at large. Service provides may be eager to offer discounts to segmented groups of users (e.g. mobile-only rates, mobile-only rates for users dining at high-end restaurants before their stay), because it permits the service provider to price-discriminate or fill inventory the service provider would not have otherwise been able to sell without “diluting their brand” by offering public discounts. For service providers that do not have sophisticated search systems, the results may be general results that any user would receive using the standard API of the service provider.

In operation 470, the results module 250 analyzes (e.g., sorts and ranks) the results to determine the best travel options to present to the users. The best travel options may be based on a combination of one or more factors such as, for example, cost, what the users are getting (e.g., free breakfast, suite vs. room, free WiFi), customer reviews including customer reviews specific to this users' demographics, user preferences (e.g., from the user profile database 270), the inferred user type and level of service (e.g., from the analysis module 230), or commission levels for an owner of the suggestion server 110. In some example embodiments, the results module 250 uses an algorithm that applies weights and scores to these factors. In some example embodiments, the results module 250 assigns extra weight to a service provider or travel option that provides a unique benefit or aspect to the users (e.g., lower rate than a public rate). The best travel options may include the travel options for the travel group, travel options for users individually, or travel options for a subset of the travel group.

In some example embodiments, results from the standard API call are cross-referenced against a pre-provided list of discounts or extras amenities. For example, each week an airline may provide a list of how much discount flights provided by the suggestion server 110 can be offered at as a function of the route or a particular type of user (e.g., affluent user, frequent flier). In another example, a hotel company provides a list of upgrades that can be provided for free to customers of the operator of the suggestion server 110 going to specific cities. The suggestion server 110 (e.g., the results module 250) can then automatically apply these discounts/upgrades to the standard search results if conditions/rules for these discounts/upgrades are satisfied. These discounts/upgrades can then be taken into consideration by the results module 250 in ranking the travel options.

In yet some example embodiments, the operator of the suggestion server 110 can include their own discounts or extras. For example, the suggestion server 110 may use models to estimate how likely a group of users would be to book at various prices for a hotel (e.g. based on other people whose calendars have had meetings in similar cities), and then offer discounts tailored to those prices on top of what the service providers offers. In some example embodiments, the suggestion server 110 can also offer customers extra discounts, for example, for purchasing flights and hotels together, booking hotels in multiple cities at the same time, or purchasing multiple flights at the same time. The suggestion server 110 can also solicit extra-discounted inventory or extra-special offers, from the service providers, for users willing to book flights and hotels together.

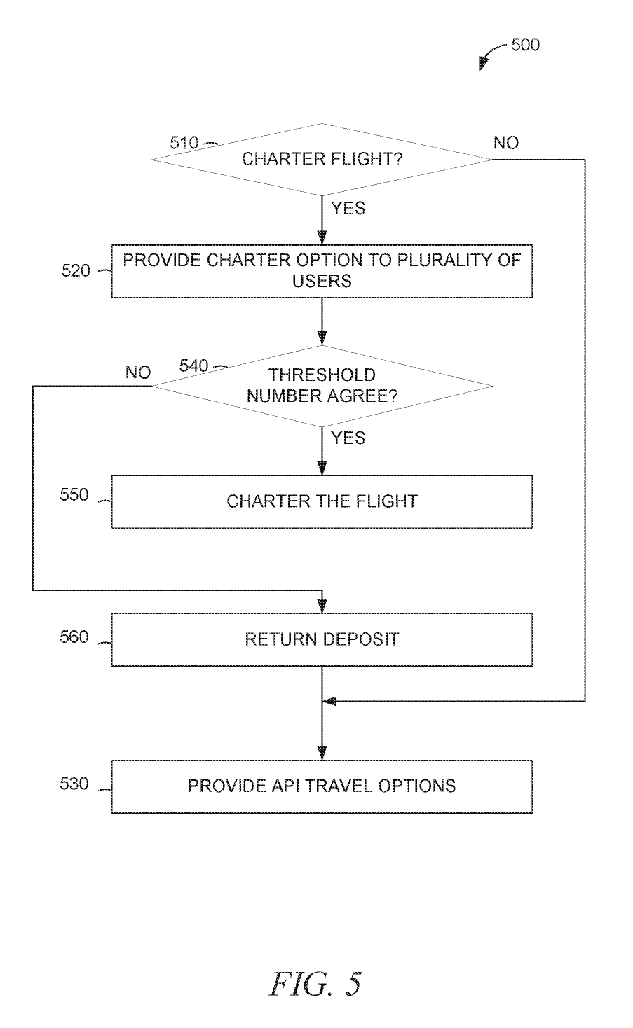

In some example embodiments, operation 470 includes determining, by the results module 250 whether a charter flight option should be presented. Operations of a method for managing a charter flight option is discussed in more detail in connection with FIG. 5 below.

In operation 480, the communications module 260 presents the travel options to the users. The communications module 260 may present the travel options by displaying or causing the display of a user interface or webpage (e.g., of a travel option search service), a notification (e.g., a pop up window), a message (e.g., an e-mail message, instant message, or a text message), or any suitable combination thereof. In some example embodiments, the communication module 260 presents the travel option in a communication directed at the users, in a communication addressed to the respective user device of each user in the group, or both. Such a communication may present the travel option among multiple travel options (e.g., for consideration by each of the users). In some example embodiments, the communications module 260 presents a top number of travel options (e.g., the top 3) as determined in operation 470. In other example embodiments, the communications module 260 present all the travel options along with recommendations of the best travel options. In some embodiments, the communication module 260 presents the group travel option(s) as well as travel options for users individually or as a subset of the travel group. This allows the users to determine whether benefits received in the group travel option(s) are worth it to each user versus, for example, waiting until a later date to book travel options.

While example embodiments discusses the options as being travel options, example embodiments are not limited to travel service providers. The service provider can be any service provider that wants to know particular information for the users and use that information to offer services. For example, the service provider can be an entertainment venue (e.g., for a location that the users will be at during a trip), restaurant, a travel insurance company, house sitters, pet boarding service, and so forth.

FIG. 5 is a flowchart illustrating operations of a method 500 for managing a charter flight option. Operations in the method 500 may be performed by the suggestion server 110, using one or more modules (e.g., the results module 250) described above with respect to FIG. 2. Accordingly, the method 500 is described by way of example with reference to the suggestion server 110. However, it shall be appreciated that at least some of the operations of the method 500 may be deployed on various other hardware configurations or be performed by similar components residing elsewhere in the network environment 100. Therefore, the method 500 is not intended to be limited to the suggestion server 110. The method 500 may be performed as part of operation 470 in accordance with some example embodiments.

In operation 510, the results module 250 determine whether, for flight travel options, a charter flight option should be presented. In some example embodiments, the results module 250 may determine that the flight options received in response to an API call are expensive (e.g., as compared to empirical or historical data). If there is a threshold number of users (e.g., more users than seats available on a flight) that require a flight to the same destination location from the same origination location during a similar timeframe, the results module 250 offers a charter flight option. In some example embodiments, the charter flight option is offered if the cost for a commercial flight is unusually high. For example, if there are 20 users requiring such a flight and commercial fares (e.g., on a. commercial airline) are $800 per person and a charter flight would cost $500 per person, the results module 250 can offer an option for the charter flight. As such, the suggestion server 110 (e.g., the results module 250) determines a cost associated with the charter flight option. In some example embodiments, the charter flight option is offered if demand is high (e.g., 200 users are traveling to the same location on the same day).

The charter flight option is provided (e.g., presented via a user interface or via other communication methods) to the users in operation 520. The charter flight option may indicate that a minimum number of users (e.g., 15 users) need to agree by a particular date and provide a refundable deposit. However, if there is not a threshold number of users requiring the flight option, then a charter flight option is not presented. In either case, travel options obtained from the API calls are caused to be presented in operation 530.

If the charter flight option is provided to the users in operation 520, a determination is made, in operation 540, as to whether a threshold number of users have agreed to take the charter flight option by the particular date and provided the refundable deposit. If the required number of users have agreed to the charter flight option by the particular date, then the flight is chartered in operation 550. However, if the required number of users have not agreed to the charter flight option by the particular date, the deposit is refunded in operation 560, and the users is provided the travel options obtained from the API call(s) to the provider servers 130 (e.g., from operation 460).

As an extension of some example embodiments, data from a plurality of users' calendars (e.g., thousands or millions of customers' calendars) is aggregated and provided (e.g., electronically transmitted) to servers of the service providers (e.g., travel suppliers) The aggregated data can be used to determine (e.g., using an algorithm) pricing (e.g., based on future projected travel demand), determine new flight routes to launch (e.g., based on higher demand on routes that an airline currently does not have non-stop flights), or recommend pop-up accommodations (e.g. that people should consider renting out their homes on a vacation rental during certain dates when many people will be in town). As such, the aggregated data can be analyzed by a server of the service provider (e.g., provider servers 130) to make more intelligent decisions on pricing and capacity planning. The aggregated data can be provided for free or for a fee.

According to various example embodiments, one or more of the methodologies described herein may facilitate communication of information about one or more travel options. In particular, one or more of the methodologies described herein may constitute all or part of a method (e.g., a method implemented using a machine) that automatically selects and presents the user with available travel options determined to be compatible with trips of multiple users. Moreover, presentation of such travel options may be conveniently integrated with calendar information, which may facilitate the making of travel plans.

When these effects are considered in aggregate, one or more of the methodologies described herein may obviate a need for certain efforts or resources that otherwise would be involved in matching users (e.g., as potential consumers of travel options) with travel options that are likely to be of interest to those users. Efforts expended by a user in identifying a travel option may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 6 illustrates components of a machine 600, according to some example embodiments, that is able to read instructions from a machine-readable medium (e.g., a machine-readable storage device, a non-transitory machine-readable storage medium, a computer-readable storage medium, or any suitable combination thereof) and perform any one or more of the methodologies discussed herein. Specifically, FIG. 6 shows a diagrammatic representation of the machine 600 in the example form of a computer device (e.g., a computer) and within which instructions 624 (e.g., software, a program, an application, an applet, an app, or other executable code) for causing the machine 600 to perform any one or more of the methodologies discussed herein may be executed, in whole or in part.

For example, the instructions 624 may cause the machine 600 to execute the flow diagrams of FIGS. 4 and 5. In one embodiment, the instructions 624 can transform the general, non-programmed machine 600 into a particular machine (e.g., specially configured machine) programmed to carry out the described and illustrated functions in the manner described.

In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624 (sequentially or otherwise) that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The machine 600 may further include a graphics display 610 (e.g., a plasma display panel (PDP), a light emitting diode (LED) display, a liquid crystal display (LCD), a projector, or a cathode ray tube (CRT), or any other display capable of displaying graphics or video). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a sound card, an amplifier, a speaker, a headphone jack, or any suitable combination thereof), and a network interface device 620.

The storage unit 616 includes a machine-readable medium 622 (e.g., a tangible machine-readable storage medium) on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered as machine-readable media (e.g., tangible and non-transitory machine-readable media). The instructions 624 may be transmitted or received over a network 626 (e.g., network 150) via the network interface device 620.

In some example embodiments, the machine 600 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 622 able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions (e.g., instructions 624). The term “machine-readable medium” shall also be taken to include any medium, or combination of multiple media, that is capable of storing instructions (e.g., software) for execution by the machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. In some embodiments, a “machine-readable medium” may also be referred to as a “machine-readable storage device” or a “hardware storage device.”

Furthermore, the machine-readable medium 622 is non-transitory in that it does not embody a propagating or transitory signal. However, labeling the machine-readable medium 622 as “non-transitory” should not be construed to mean that the medium is incapable of movement—the medium should be considered as being transportable from one physical location to another. Additionally, since the machine-readable medium 622 is tangible, the medium may be considered to be a tangible machine-readable storage device.

In some example embodiments, the instructions 624 for execution by the machine 600 may be communicated by a carrier medium. Examples of such a carrier medium include a storage medium (e,g., a non-transitory machine-readable storage medium, such as a solid-state memory, being physically moved from one place to another place) and a transient medium (e.g., a propagating signal that communicates the instructions 624)

The instructions 624 may further be transmitted or received over a communications network 626 using a transmission medium via the network interface device 620 and utilizing any one of a number of well-known transfer protocols (e.g., HTTP). Examples of communication networks 626 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 624 for execution by the machine 600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations,

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)),

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
accessing, by a suggestion server, calendar data for each user of a plurality of users, the calendar data indicating, for each user, a corresponding event each user is scheduled to attend;
extracting, from the calendar data by the suggestion server, data that describes the corresponding event each user is scheduled to attend, the extracted data including location data and time data for each corresponding event;
grouping, by one or more hardware processors of the suggestion server, a subset of the plurality of users into a travel group based on the location data for each user in the travel group indicating locations within a predetermined distance threshold of each other and based on the time data for each user in the travel group indicating times within a predetermined time threshold of each other;
automatically generating, by the suggestion server, an application program interface (API) request to a server of a service provider, the automatically generating comprising including the extracted data of the travel group as a search criteria in the API request;
transmitting, over a network by the suggestion server, the automatically generated API request to the server of the service provider;
in response to the transmitting, receiving, by the suggestion server, results from the server of the service provider, the results including a group travel option indicating a block of inventory selected for the travel group; and
causing, by the suggestion server, presentation of the results to the travel group.

2. The method of claim 1, wherein the group travel option comprises a discount not available from individual travel options for individual users of the travel group.

3. The method of claim 1, wherein the group travel option comprises an amenity not available for travel options for individual users of the travel group.

4. The method of claim 1, further comprising:
determining whether to present a charter flight option; and
based on the determining to present the charter flight option, causing presentation of the charter flight option, the charter flight option indicating that a threshold number of users need to agree to select the charter flight option by a particular date.

5. The method of claim 4, wherein the determining whether to present the charter flight option comprises determining that there are more users in the travel group than seats available on a commercial flight.

6. The method of claim 4, wherein the determining whether to present the charter flight option comprises determining that a cost of a commercial flight option is higher compared to empirical or historical data.

7. The method of claim 4, further comprising:
determining whether the threshold number of users agreed to select the charter flight option; and
in response to the determining that the threshold number of users agreed, chartering a flight.

8. The method of claim 4, further comprising:
determining whether the threshold number of users agreed to select the charter flight option; and
in response to the determining that the threshold number of users have not agreed, returning a deposit provided by users that agreed to the charter flight option.

9. The method of claim 1, further comprising:
generating a further API request for a subset of the travel group;
transmitting, over the network to the server of the service provider, the further API request;
receiving results based on the further API request; and
causing presentation of the results based on the further API request to the subset of the travel group.

10. A hardware storage device storing instructions that, when executed by one or more processors of a machine, cause the machine to perform operations comprising:
accessing calendar data for each user of a plurality of users, the calendar data indicating, for each user, a corresponding event each user is scheduled to attend;
extracting, from the calendar data, data that describes the corresponding event each user is scheduled to attend, the extracted data including location data and time data for each corresponding event;
grouping a subset of the plurality of users into a travel group based on the location data for each user in the travel group indicating locations within a predetermined distance threshold of each other and based on the time data for each user in the travel group indicating times within a predetermined time threshold of each other;
automatically generating an application program interface (API) request to a server of a service provider, the automatically generating comprising including the extracted data of the travel group as a search criteria in the API request;
transmitting, over a network, the automatically generated API request to the server of the service provider;
in response to the transmitting, receiving results from the server of the service provider, the results including a group travel option indicating a block of inventory selected for the travel group; and
causing presentation of the results to the travel group.

11. The hardware storage device of claim 10, wherein the group travel option comprises a discount not available from individual travel options for individual users of the travel group or an amenity not available for travel options for individual users of the travel group.

12. The hardware storage device of claim 10, wherein the operations further comprise:
determining whether to present a charter flight option; and
based on the determining to present the charter flight option causing presentation of the charter flight option, the charter flight option indicating that a threshold number of users need to agree to select the charter flight option by a particular date.

13. The hardware storage device of claim 12, wherein the determining whether to present the charter flight option comprises determining that there are more users in the travel group than seats available on a commercial flight or determining that a cost of a commercial flight option is higher compared to empirical or historical data.

14. The hardware storage device of claim 12, wherein the operations further comprise:
determining whether the threshold number of users agreed to select the charter flight option; and
in response to the determining that the threshold number of users agreed, chartering a flight.

15. The hardware storage device of claim 12, wherein the operations further comprise:
determining whether the threshold number of users agreed to select the charter flight option; and
in response to the determining that the threshold number of users have not agreed, returning a deposit provided by users that agreed to the charter flight option.

16. The hardware storage device of claim 10, wherein the operations further comprise:
generating a further API request for a subset of the travel group;
transmitting, over the network to the server of the service provider, the further API request;
receiving results based on the further API request; and
causing presentation of the results based on the further API request to the subset of the travel group.

17. A system comprising:
one or more hardware processors; and
a storage device storing instructions that, when executed by the one or more hardware processors, causes the one or more hardware processors to perform operations comprising:
accessing calendar data for each user of a plurality of users, the calendar data. indicating, for each user, a corresponding event each user is scheduled to attend;
extracting, from the calendar data, data that describes the corresponding event each user is scheduled to attend, the extracted data including location data and time data for each corresponding event;
grouping a subset of the plurality of users into a travel group based on the location data for each user in the travel group indicating locations within a predetermined distance threshold of each other and based on the time data for each user in the travel group indicating times within a predetermined time threshold of each other;
automatically generating an application program interface (API) request to a server of a service provider, the automatically generating comprising including the extracted data of the travel group as a search criteria in the API request;
transmitting, over a network, the automatically generated API request to the server of the service provider;
in response to the transmitting, receiving results from the server of the service provider, the results including a group travel option indicating a block of inventory selected for the travel group; and
causing presentation of the results to the travel group.

18. The system of claim 17, wherein the group travel option comprises a discount not available from individual travel options for individual users of the travel group or an amenity not available for travel options for individual users of the travel group.

19. The system of claim 17, wherein the operations further comprise:
determining whether to present a charter flight option; and
based on the determining to present the charter flight option, causing presentation of the charter flight option, the charter flight option indicating that a threshold number of users need to agree to select the charter flight option by a particular date.

20. The system of claim 17, wherein the determining whether to present the charter flight option comprises determining that there are more users in the travel group than seats available on a commercial flight or determining that a cost of a commercial flight option is higher compared to empirical or historical data.
